(19) United States
(12) Patent Application Publication
(10) Pub. No.: US 2024/0239638 A1
(43) Pub. Date: Jul. 18, 2024

(54) APPARATUS AND SYSTEM FOR GUIDING A CARPET ROLL

(71) Applicant: Wayne Stull, Cabot, AR (US)

(72) Inventor: Wayne Stull, Cabot, AR (US)

(21) Appl. No.: 18/414,303

(22) Filed: Jan. 16, 2024

Related U.S. Application Data
(60) Provisional application No. 63/438,811, filed on Jan. 13, 2023.

(51) Int. Cl. B66F 9/08; B66F 9/18; G01C 15/00

(52) U.S. Cl. CPC B66F 9/08; B66F 9/18; G01C 15/004

(57) ABSTRACT

A light-based guidance system is disclosed that is mountable on a pole of a lifting device for carpet rolls. The light-based guidance system includes a light source disposed within a housing of the light-based guidance system, wherein the light source is configured to emit a light beam that is substantially parallel with the pole member.

### CROSS REFERENCE TO RELATED APPLICATIONS

This application claims the benefit of Provisional Application No. 63/438,811 filed on Jan. 13, 2023 which is hereby incorporated herein by reference.

### TECHNICAL FIELD

This disclosure relates to lifting guidance systems and apparatuses, and more particularly to apparatuses and system for guiding carpet rolls.

### BACKGROUND

The statements in this section merely provide background information related to the present disclosure and may not constitute prior art.

Forklifts or similar load handling equipment are designed to handle pallets and the like by inserting a pair of forks or tines into access openings provided between opposing deck members or the pallet legs for a single deck pallet. The forks are mounted in parallel on a carriage which can be raised or lowered vertically and usually also tilted slightly, with the forks extending typically a distance of between three feet and seven feet, although different forklifts may utilize different sized forks. Similarly, “forklifts” may be adapted for loading and handling carpet rolls. Instead of tines or forks, the “forklift” may be fitted with a pole or elongated bar. The pole may then be inserted in the center of a carpet roll, which is typically hollow.

In a carpet warehouse setting, it may be desirable to operate the forklifts to raise carpet rolls many feet off the ground such that multiple rolls can be stacked, minimizing the amount of floor space taken up. Thus, even though the operator is seated on the forklift itself and is therefore a few feet above ground level, the carpet roll may need to be deposited onto or retrieved from a stack, rack or shelf many feet above the operator.

The proximity of the operator to the pole and carpet roll and the line of sight of the operator relative to the pole and carpet roll make it difficult for the operator to determine if the pole is at the preferential height prior to advancing the pole forward to retrieve the carpet roll onto the stack, rack or shelf. Under these conditions, operators estimate the correct height of the pole, then advance the pole forward to determine, by striking the carpet roll itself when retrieving, that the pole is misaligned. This technique can result in damage to the pole or the carpet roll and to the shelves or racks. Line of sight problems additionally inhibit accurate positioning and placement of carpet rolls unto a surface such as a rack or shelf.

Accordingly, a need exists for a guidance system to indicate to the operator the position of the pole relative to the carpet roll. This combination enables new levels of warehousing efficiency by improving loading and unloading times and saving considerable expense and improving service levels by decreasing misplaced and damaged loads.

### SUMMARY

A light-based guidance system is disclosed that is mountable on a pole of a lifting device for carpet rolls. The light-based guidance system includes, a light source disposed within a housing of the light-based guidance system, wherein the light source is configured to emit a light beam that is substantially parallel with the pole member.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 depicts an exemplary forklift including a light-based guidance system, in accordance with the present disclosure;

FIG. 2A-2C shown an exemplary light-based guidance device, in accordance with the present disclosure;

FIG. 3 is a front view of the exemplary light-based guidance device, in accordance with the present disclosure;

FIG. 4 is a cross-sectional view along the line A-A of FIG. 3 of the exemplary light-based guidance device, in accordance with the present disclosure;

FIG. 5 is an exploded view of the exemplary light-based guidance device, in accordance with the present disclosure;

FIG. 6 is an exemplary side view of the device in operation, in accordance with the present disclosure;

FIG. 7 is a schematical view of an exemplary system for controlling the exemplary light-based guidance device, in accordance with the present disclosure; and

FIG. 8 is an exemplary process for controlling the exemplary light-based guidance device, in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

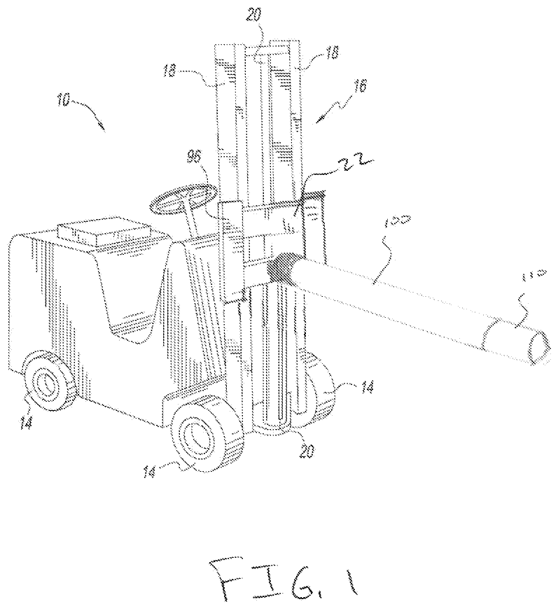

Referring now to the drawings, wherein the depictions are for the purpose of illustrating certain exemplary embodiments only and not for the purpose of limiting the same, FIG. 1 shows an exemplary lifting vehicle 10, including a light-based guidance system 110, which has been constructed in accordance with an embodiment of the disclosure. One skilled in the art will readily appreciate that the disclosure described herein may be readily applied to various lifting vehicles and lifting vehicle systems, forklifts, lift trucks other similar pieces of equipment, and is therefore not limited thereby.

The exemplary lifting vehicle 10 includes an operator area mounted on wheels 14 and a lift mechanism 16 comprising lift support tracks 18 and mast 20. The lift support tracks 18 are parallel with the mast 20. The lift mechanism 16 is mounted to a front of the lifting vehicle 10 in forward view of a lifting vehicle operator in the operator area. In one embodiment, the operator area includes lifting vehicle controls and an area for the lifting vehicle operator to ride the lifting vehicle 10. The lifting vehicle 10 includes a carriage assembly 22 configured to support a load bearing members, e.g., pole 100, by selectively traversing up and down the lift support track 18. In one embodiment, the mast 20 is a telescopic mast structure operatively connected to one or more hydraulic cylinders with piston rods to actuate the carriage along the lift support tracks 18.

The pole 100 extends in a forward direction, and are adapted to fit into an access openings of a carpet roll and to support a mass of the carpet roll. In one embodiment, the pole is an elongated member, perpendicular to the mast 20 and tracks 18. The pole is proximate to load stop member 96.

In operation, the pole 100 is inserted into a carpet roll, whereby the roll can be raised from a rack, shelf or stack for subsequent transport. The pole 100 are inserted subsequent to raising or lowering the carriage 22 to the proper height relative to the carpet roll and then advancing the lifting vehicle 10 in the forward direction, or the lifting vehicle carriage, in one embodiment. The pole 100 fit within a center of a carpet roll.

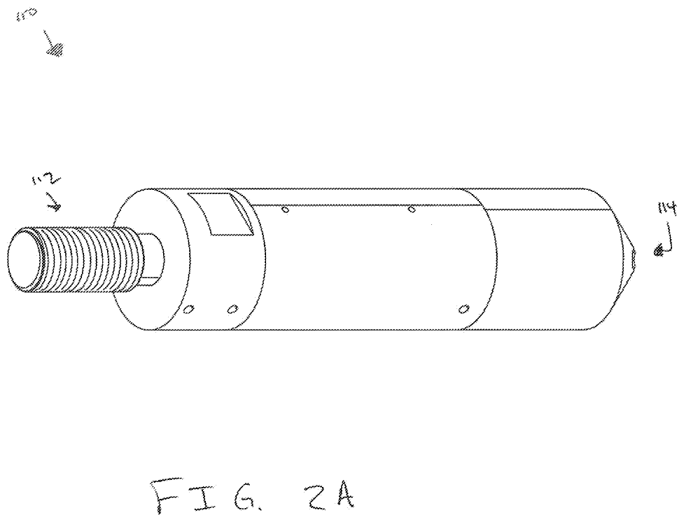

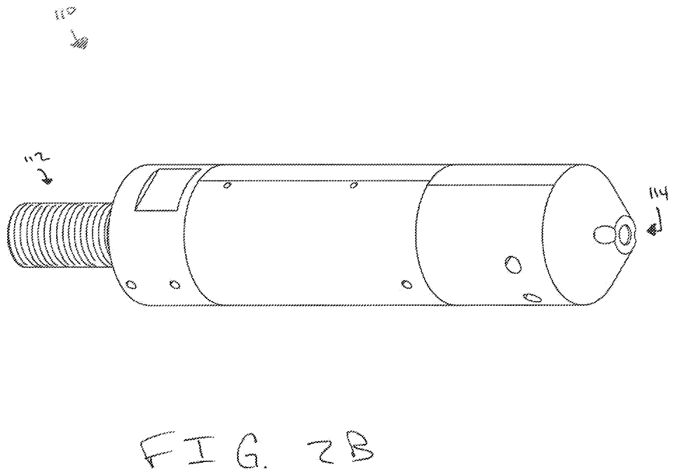

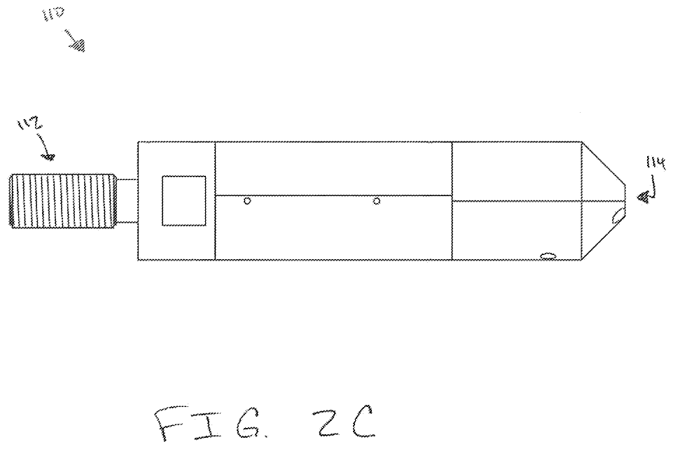

FIGS. 2A-2C depict an exemplary light-based guidance device 110. As FIGS. 2A-2C show, the light-based guidance device 110 is generally cylindrical-shaped with a frustum-conical-shaped end. The cylindrical shape and frustum-conical end is preferential for fitting within a carpet roll during use. The device 110 is preferably sized to house a power source, control unit, and light emitting device. The light-based guidance device 110 includes an attached threaded mechanism 112 from which to selectively attach to corresponding threads within the pole 100. The light-based guidance system 110 includes an aperture 114 at an opposing end relative to the threaded mechanism 112.

In one embodiment, the device 110 draws power from a common source with the lifting device 10, such as the vehicle battery. The power source can also be a separate battery and/or solar power within the housing or integral therewith.

In one embodiment, calibrating mechanisms may be accessed through the housing of the device 110. In this way, a user may adjust an angle that the light beam emitting device emits along a vertical and/or horizontal axis using adjustment mechanisms. An adjustment lock can be included to lock the calibration.

In one embodiment, the device 110 includes a ranging sensor. The ranging sensor may be any one of multiple systems configured to determine a height of the device 110 with respect to a ground or floor level including light-based sensors utilizing photosensors or lasers, or sound-based sensors utilizing sonar such as an ultrasonic range finding device.

The light beam emitting device may comprise any suitable apparatus for producing a collimated or focused beam of light in the visible spectrum, such as standard light bulbs or LEDs in combination with focusing lenses or mirrors, but is preferably comprised of a laser module configured to produce a controlled light beam. For example, laser modules containing a diode and focusing lens arrangement can produce a light beam with a wavelength between 300 to 1200 nm. Alternate colors may be produced using different wavelength ranges on the visible or infra-red light spectrum.

The light beam emitting device is preferably disposed within a housing of the device 110. The light beam emitting device is preferably mounted within the housing such that the trajectory of a light beam is substantially parallel with the pole 100 and emitted on a same horizontal plane of the pole 100. In this way, the light beam indicates an end point of a forward path trajectory of the pole 100 when the pole 100 is advancing.

A lens may be fitted over the light beam emitting device in such a manner to shape the controlled light beam into a shape. For example, one such lens may laterally elongate a light beam in such a manner that a horizontal line is irradiated on an opaque surface. In one embodiment of a lens, the light beam is shaped into a cross shape. In one embodiment, the light beam emitting device is fitted with a lens configured to shape the light beam into a dot shaped irradiation.

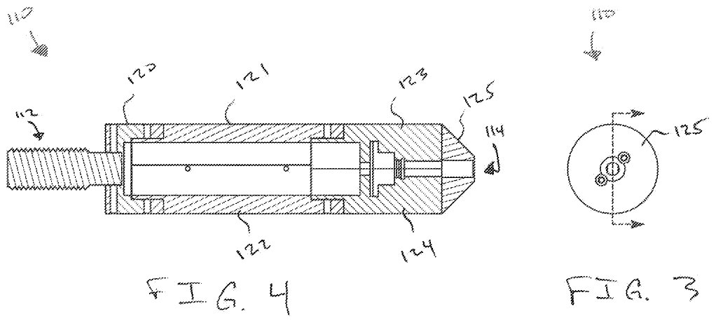

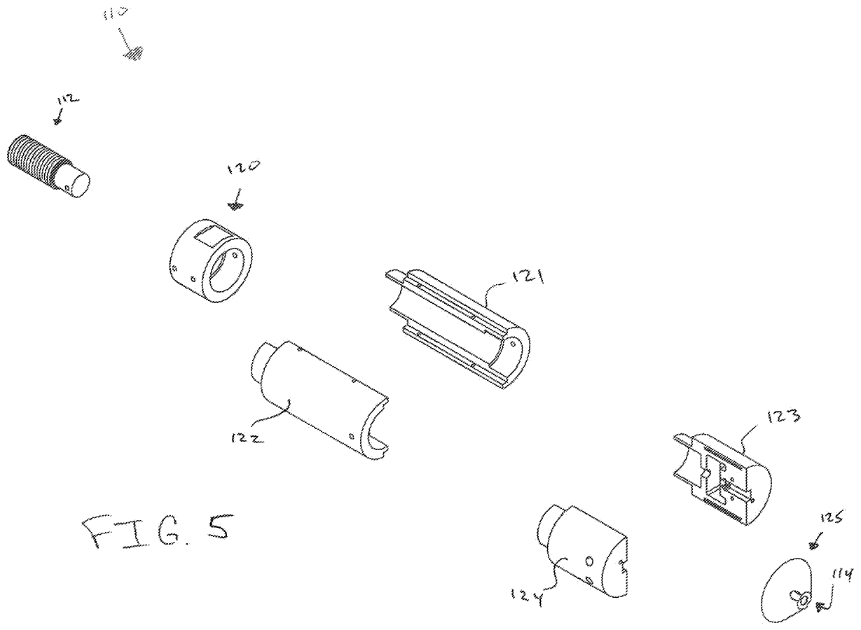

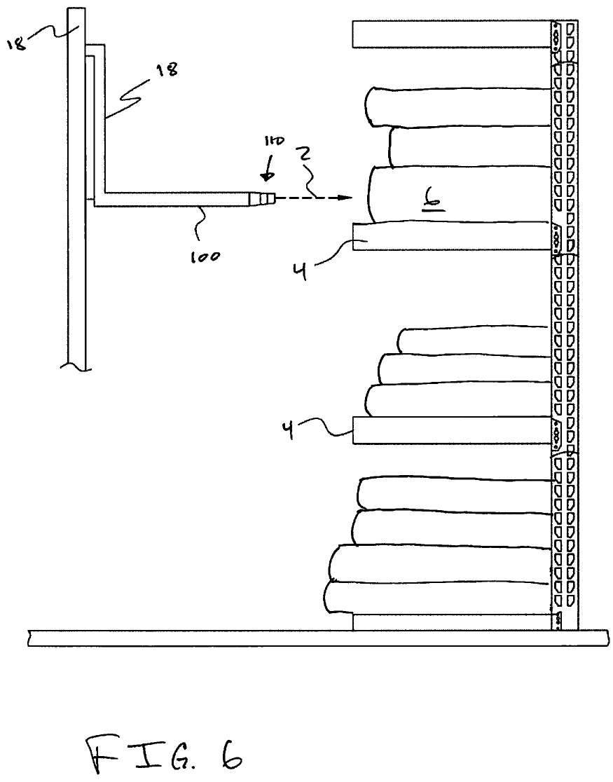

FIGS. 3-5 shows various views of the device 110, generally depicting an exemplary housing arrangement for internal components such as a battery, control unit, and light emitting device. In one embodiment, the device 110 is formed of a cylindrical-shaped module 120 configured for attachment to the threaded mechanism 112 and components 121 and 122. Components 121 and 122 are generally cylindrical-shaped and configured to house internal components such as mentioned hereinabove. Components 121 and 122 can be attached to components 123 and 124, which are generally cylindrical-shaped and can be configured to house internal components such as mentioned hereinabove. The components 123 and 124 can be attached to module 125, which is frustum-conical-shaped to aid insertion within a carpet roll and includes aperture 114.

FIG. 6 shows the device 110 in operation including an exemplary light beam 2. FIG. 6 is a side view of the device 110 in operation prior to the lifting vehicle operator inserting the pole 100 into the carpet roll 6. The light beam 2 is emitted from the light beam emitting device 110 and provides a visual indicator to the lifting vehicle operator of the height of the pole 100 relative to the object upon which the light beam impinges. The light beam 2 can be emitted before advancing the pole 100 under a load. Subsequent to loading a load on the pole 100, the light beam 100 can be discontinued.

Prior to inserting the pole 100 into the carpet roll 6, the lifting vehicle operator adjusts the height of the pole 100 based upon the visual indication from the light beam 2 emitted from the device 110. As described herein above, the specific visual indication produced for the lifting vehicle operator may vary based upon color, shape, and frequency of emission. Shape is determined based upon the particular lens fitted over the device 110. In an embodiment wherein the light beam is shaped into a dot, a preferential height of the carriage is indicated on a pallet when the dot impinges a center support or, alternatively, when the dot visually disappears into an access opening of the carpet roll, thereby indicating to the operator that the pole 100 are correctly positioned for insertion. Conversely, if the pole 100 is not at a preferential height, the light beam 2 will impinge on an upper or lower part of the carpet roll 6, or a shelf or support rack 4. The position of the visible dot on these objects indicates to the operator whether to adjust the height of the pole 100 for unimpeded insertion into the carpet roll 6. In an embodiment wherein the light beam is shaped into a horizontal line, a preferential height of the pole 100 is indicated on a carpet roll when the horizontal line impinges over a substantially central line with respect to a height of the carpet roll 6, thereby indicating to the operator that the pole 100 is correctly positioned for insertion. Conversely, if the pole 100 is not at a preferential height, the horizontal line will impinge at a higher or lower height with respect to a central height of the pallet.

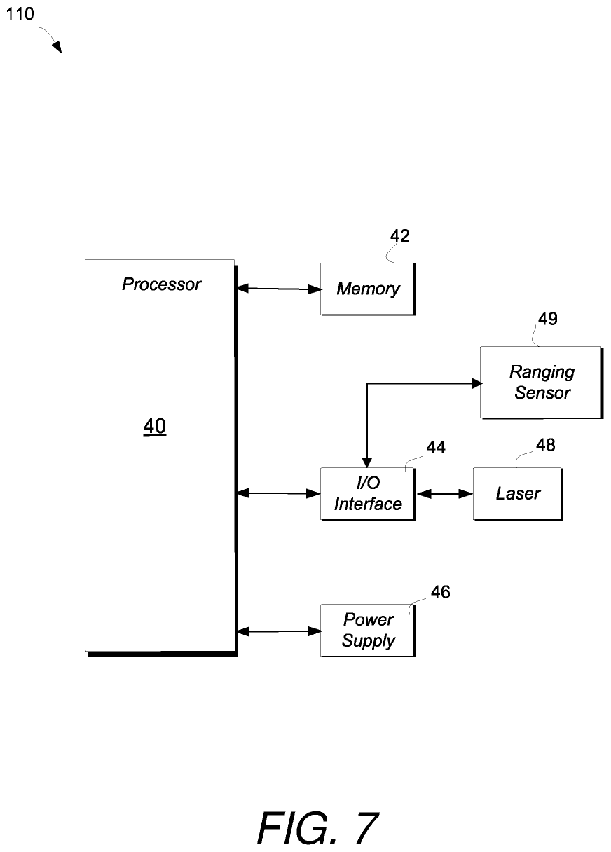

FIG. 7 schematically shows the device 110. As FIG. 7 shows, the device 110 may include a processor 40. The device 110 may additionally include any digital and/or analog circuit elements, comprising discrete and/or solid state components, suitable for use with the embodiments disclosed herein, e.g., LEDs, ON/OFF switch. One skilled in the art will recognize upon a careful reading of the teachings herein that the radio processor may be included in a wireless embodiment of the device 110.

The processor module 40 may be configured to execute various computer programs (e.g., software, firmware, or other code) such as application programs and system programs to provide computing and processing operations for the device 110. In various embodiments, the processor module 40 may be implemented as a central processing unit (“CPU”) using any suitable processor or logic device, such as a general purpose processor, or other processing device in alternative embodiments configured to provide processing or computing resources to device 110. For example, host processor module 40 may be responsible for executing various computer programs such as application programs and system programs to provide computing and processing operations for device 110, e.g., ranging determinations. The computer programs may be stored as firmware on a memory associated with processor 40, may be loaded by a manufacturer during a process of manufacturing the device 110, and may be updated from time to time with new versions or software updates via wired or wireless communication.

The memory module 42 is preferably coupled to the host processor module 40. In various embodiments, the memory module 42 may be configured to store one or more computer programs to be executed by the host processor module 40. The memory module 42 may be implemented using any machine-readable or computer-readable media capable of storing data such as volatile memory or non-volatile memory, removable or non-removable memory, erasable or non-erasable memory, writeable or re-writeable memory, and so forth. Although the memory module 42 is shown as being separate from the host processor module 40 for purposes of illustration, in various embodiments some portion or the entire memory module 42 may be included on the same integrated circuit as the processor module 40. Alternatively, some portion or the entire memory module 42 may be disposed on an integrated circuit or other medium (e.g., solid state drive) external to the integrated circuit of the host processor module 40.

An I/O interface 44 is preferably coupled to the host processor module 40. The I/O interface 44 may include one or more I/O devices such as a serial connection port, an infrared port, wireless capability, and/or integrated 802.11x (WiFi) wireless capability, to enable wired (e.g., USB cable) and/or wireless connection to a local or networked computer system, such as a workstation client, and/or a server.

A power supply 46 configured to supply and manage power to components of device 110 is preferably coupled to the host processor module 40. In various exemplary embodiments, the power supply 46 may be implemented by a rechargeable battery, such as a removable and rechargeable lithium ion battery to provide direct current (“DC”) power, and/or an alternating current (“AC”) adapter to draw power from a standard AC main power supply.

The device 110 includes a light emitting device, which may be a laser 48. The laser 48 may be directly coupled to the processor 40 or connected through one or more other modules including, e.g., the I/O interface 44, such as shown in FIG. 7.

In one embodiment, the device 110 includes a ranging sensor 49. The ranging sensor 49 may be any one of multiple systems configured to determine a height of the device 110 with respect to a ground or floor level including light-based sensors utilizing photosensors or lasers, or sound-based sensors utilizing sonar such as an ultrasonic range finding device. In one embodiment, the ranging sensor 49 may determine, or estimate, horizontal distance from a forward object of the device 110.

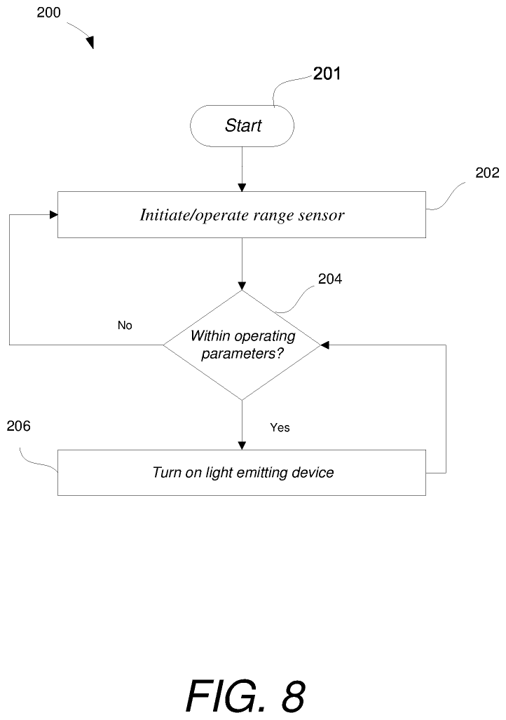

FIG. 8 shows an exemplary process 200 for controlling the device 110. The process 200 may be initialized manually or automatically in accordance with other executing processes. In one embodiment, the process 200 is initialized 201 by simply turning the device 110 to an ON operating state. In one embodiment, the process 200 is initialized by receiving instructions from a computer program to start. In one embodiment, one or more criteria may be used to initiate the process 200 including, e.g., input received from a sensor.

Subsequent to initializing the process 200, the device 110 initiates or transitions the ranging sensor 49 to an ON operating state at step 202. In various embodiments, the ranging sensor 49 must indicate a pre-defined height from ground before turning ON. In this way, battery power may be conserved, or safety protocols adhered to.

Subsequent to step 202, the process 200 determines at step 204 whether input from the ranging sensor is within operating parameters. If the input is within operating parameters, because, for example, a height above floor level is determined, then the process will turn the light emitting device 48 to an ON operating state at step 206. If the height above floor level is not within predefined operating parameters, then the process will loop back to step 202 and continue monitoring via the ranging sensor 49.

In one embodiment, the device 110 initiates or transitions the laser 48 to an ON operating state via user input. The laser 48 can then be transitioned to an OFF operating state via user input.

The schematic flow chart diagrams included herein are generally set forth as logical flow chart diagrams. As such, the depicted order and labeled steps are indicative of one embodiment of the presented process. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the process. For example, an arrow may indicate a waiting or monitoring period of unspecified duration between enumerated steps of the depicted process. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Additionally, the order in which a particular method occurs may or may not strictly adhere to the order of the corresponding steps shown. For example, two blocks shown in succession may in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures. For example, steps 202 and 206 may be executed concurrently in some embodiments.

Additionally, examples in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may for instance, comprise one or more physical or logical blocks of computer instructions which may for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A light-based guidance system mountable on a pole of a lifting device for carpet rolls, the light-based guidance system comprising:
a light source disposed within a housing of the light-based guidance system, wherein the light source is configured to emit a light beam that is substantially parallel with the pole member.

2. The light-based guidance system of claim 1, further comprising:
an attachment mechanism configured to couple to an end the pole of a lifting device.

3. The light-based guidance system of claim 2, wherein the attachment mechanism is a threaded element configured to couple into a corresponding female threaded recess of the pole.

4. The light-based guidance system of claim 1, wherein the light-based guidance system is configured to couple to the pole in axial alignment with the pole.

5. The light-based guidance system of claim 1, wherein the light source is situated in the housing so that the light source is in axial alignment with the pole when the light-based guidance system is coupled thereto.

6. The light-based guidance system of claim 1, wherein the housing is substantially cylindrical-shaped with a frustum-conical-shaped end.

7. The light-based guidance system of claim 6, wherein the frustum-conical-shaped end comprises an opening in axial alignment with the pole.

8. The light-based guidance system of claim 7, wherein the opening is configured to permit the light beam to exit the housing.

9. The light-based guidance system of claim 1, further comprising:
a ranging sensor configured to selectively control the light source based upon height from ground.

10. A light-based guidance system mountable on a pole of a lifting device for carpet rolls, the light-based guidance system comprising:
a light source disposed within a housing of the light-based guidance system, wherein the light source is configured to emit a light beam that is substantially in axial alignment with the pole member.

11. The light-based guidance system of claim 10, further comprising:
an attachment mechanism configured to couple to an end the pole of a lifting device.

12. The light-based guidance system of claim 11, wherein the attachment mechanism is a threaded element configured to couple into a corresponding female threaded recess of the pole.

13. The light-based guidance system of claim 10, wherein the light-based guidance system is configured to couple to the pole in axial alignment with the pole.

14. The light-based guidance system of claim 10, wherein the light source is situated in the housing so that the light source is in axial alignment with the pole when the light-based guidance system is coupled thereto.

15. The light-based guidance system of claim 10, wherein the housing is substantially cylindrical-shaped with a frustum-conical-shaped end.

16. The light-based guidance system of claim 15, wherein the frustum-conical-shaped end comprises an opening in axial alignment with the pole.

17. The light-based guidance system of claim 16, wherein the opening is configured to permit the light beam to exit the housing.

18. The light-based guidance system of claim 10, further comprising:
a ranging sensor configured to selectively control the light source based upon height from ground.

19. A light-based guidance system mountable on a pole of a lifting device for carpet rolls, the light-based guidance system comprising:
a light source disposed within a housing of the light-based guidance system, wherein the light source is configured to emit a light beam that is substantially in axial alignment with the pole member, wherein the housing is substantially cylindrical-shaped with a frustum-conical-shaped end, wherein the frustum-conical-shaped end comprises an opening in axial alignment with the pole, wherein the opening is configured to permit the light beam to exit the housing;
an attachment mechanism configured to couple to an end the pole of a lifting device.

20. The light-based guidance system of claim 10, further comprising:
a ranging sensor configured to selectively control the light source based upon height from ground.
